(19) United States
(12) Patent Application Publication
(10) Pub. No.: US 2010/0024413 A1
(43) Pub. Date: Feb. 4, 2010

(54) ENGINE FOR ENERGY CONVERSION

(76) Inventor: SEONG WOONG KIM, Flushing, NY (US)

Correspondence Address: GREENBERG TRAURIG, LLP, 200 PARK AVE., P.O. BOX 677, FLORHAM PARK, NJ, 07932, US

(21) Appl. No.: 12/533,031

(22) Filed: Jul. 31, 2009

Related U.S. Application Data
(60) Provisional application No. 61/085,978, filed on Aug. 4, 2008.

(51) Int. Cl. F03B 17/02

(52) U.S. Cl. 60/496

(57) ABSTRACT

An engine is powered by a hot liquid zone and a cold liquid zone. A plurality of fluid-tight containers, each which contains a working fluid which expands when exposed to the hot liquid zone and contracts when exposed to the cold liquid zone, are attached to a loop which rotates over sprockets attached to shafts. The difference in the buoyant forces acting on the containers exposed to the hot liquid zone versus the buoyant forces acting on the containers exposed to the cold liquid zone produces motion in the loop which imparts rotational kinetic energy to the shafts.

### CROSS REFERENCE TO RELATED APPLICATION

The present invention claims the benefit of U.S. Provisional Patent Application Ser. No. 61/085,978 filed Aug. 4, 2008, the disclosure of which is incorporated herein by reference in its entirety.

### FIELD OF THE INVENTION

The present invention relates to an engine for converting thermal energy to kinetic energy.

### BACKGROUND OF THE INVENTION

The conversion of thermal energy to kinetic energy has long been utilized in the production of work. Many of the conversions use un-renewable thermal energy sources such as oil, coal, and/or natural gas which pollute the environment with undesirable by-products of combustion (e.g., carbon dioxide). It is therefore desirable to use renewal thermal energy sources such as geothermal to produce kinetic energy.

### SUMMARY OF THE INVENTION

An engine for converting thermal energy to kinetic energy includes a body of fluid having a first zone and second zone. A thermal energy source is thermally connected to the first zone for providing thermal energy to the first zone, while a thermal energy sink is thermally connected to the second zone for removing thermal energy from the second zone. A movable loop also extends between the first zone and the second zone, while fluid-tight containers are immersed in the body of fluid and are attached to the loop. Each of the containers are moveable between the first zone and the second zone and has a working fluid therein. The working fluid of each of the containers absorbs thermal energy and thereby causes a corresponding one of the containers to expand to a first volume when the corresponding one of the containers is in the first zone and releases thermal energy therefrom and thereby causes the corresponding one of the containers to contract to a second volume when the corresponding one of the containers is in the second zone, whereby the expansion and contraction of the containers cause the containers and hence the loop to move.

### BRIEF DESCRIPTION OF THE DRAWINGS

For a more complete understanding of the present invention, reference is made to the following detailed description of exemplary embodiments considered in conjunction with the accompanying drawings, in which:

FIG. 1 is a cross-sectional schematic side view of an engine constructed in accordance with a first embodiment of the present invention, the engine having a plurality of fluid-tight containers depicted in sectional views for clarity;

FIG. 2 is an enlarged cross-sectional view of one of the gas tight containers shown in FIG. 1, the container being shown in its contracted position;

FIG. 3 is an enlarged cross-sectional view of one of the containers shown in FIG. 1, the container being shown in its expanded position; and

FIG. 4 is partial cross-sectional schematic side view of an engine constructed in accordance with a second embodiment of the present invention.

### DETAILED DESCRIPTION OF THE EXEMPLARY EMBODIMENT

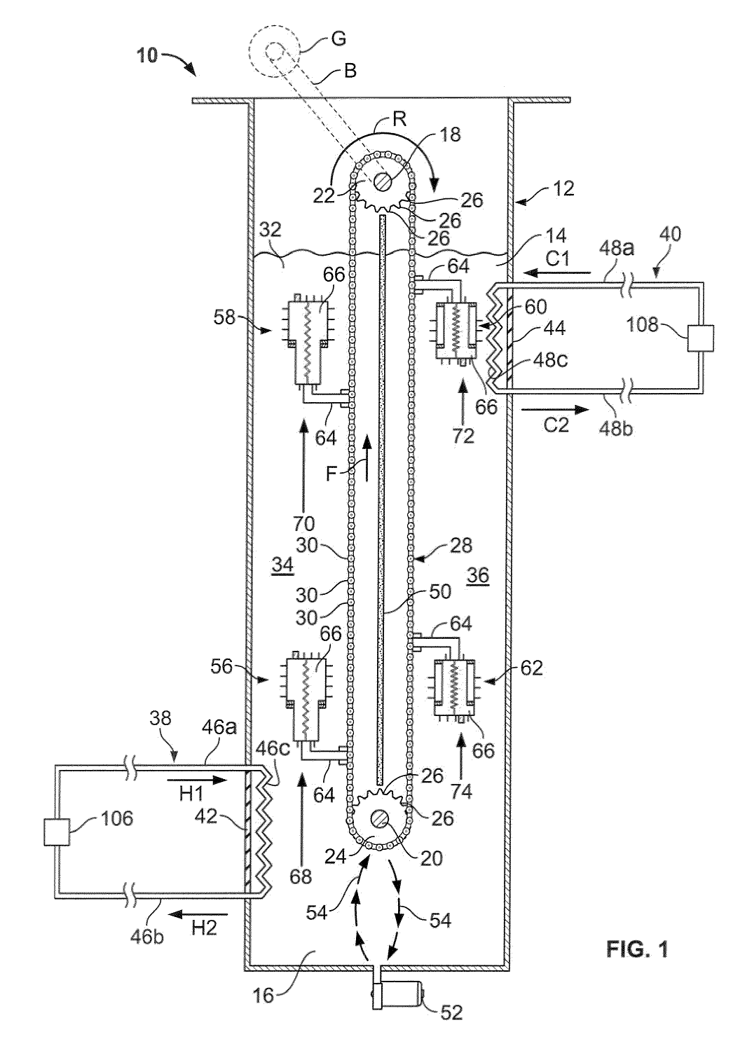

FIG. 1 illustrates an engine 10 constructed in accordance with an exemplary embodiment of the present invention for converting thermal energy into kinetic energy. The engine 10 has a housing 12, which has an upper area 14 and a lower area 16. Upper and lower shafts 18, 20 are rotatably supported by the housing 12 in the upper and lower areas 14, 16, respectively, and include upper and lower sprockets 22, 24, respectively, which are fixedly mounted thereon and each of which is equipped with teeth 26. A loop of chain 28 (e.g., a loop of roller-chain, belt, cable, etc.) having a plurality of links 30 is provided so as to roll over the upper and lower sprockets 22, 24. More particularly, the links 30 of the chain 28 are adapted to mesh with the teeth 26 of the upper and lower sprockets 22, 24 so that longitudinal movement in the chain 28 produces rotational movement in the sprockets 22, 24 and hence the upper and lower shafts 18, 20.

Liquid 32 (e.g., water or any other suitable fluid) is contained in the housing 12 and has a hot liquid zone 34 and a cool liquid zone 36. A thermal energy source 38 and a thermal energy sink 40 are connected to the hot and cold liquid zones 34, 36, respectively, and are retained by liquid-tight seals 42, 44, respectively. The thermal energy source 38 includes pipes or tubes 46a, 46b and a heat exchanger 46c, which is connected to the pipes 46a, 46b, for providing thermal energy to the hot liquid zone 34. More particularly, hot liquid or gas (not shown), which is heated by a renewable energy source 106 (e.g., solar, geothermal, ocean-thermal, etc.), flows through the pipe 46a into the hot liquid zone 34 (as indicated by arrow H1 in FIG. 1). The hot liquid or gas then flows through the heat exchanger 46c, wherein thermal energy is transferred to the hot liquid zone 34, and out of the hot liquid zone 34 through the pipe 46b (as indicated by arrow H2 in FIG. 1). Similarly, the thermal energy sink 40 includes pipes or tubes 48a, 48b and a heat exchanger 48c, which is connected to the pipes 48a, 48b, for removing thermal energy from the cold liquid zone 36. More particularly, cold liquid or gas (not shown), which is cooled by a renewable energy sink 108 (e.g., geothermal, ocean-thermal, etc.), flows through the tubing 48a into the cold liquid zone 36 (as indicated by arrow C1 in FIG. 1). The cold liquid or gas then flows through the heat exchanger 48c, wherein thermal energy is removed from the cold liquid zone 36, and out of the cold liquid zone 36 through the pipe 48b (as indicated by arrow O2 in FIG. 1). The heat exchanger 46c and the heat exchanger 48c may be provided with conventional heat transfer mechanisms (e.g., fins) that facilitate the transfer of heat into and out of the hot and cold liquid zones 34, 36, respectively. Moreover, to promote heat exchange efficiently, the energy source 38 is positioned proximate the lower area 16 of the housing 12, while the energy sink 40 is positioned proximate the upper area 14 of the housing 12 (e.g., proximate the upper sprocket 22).

A baffle 50 is positioned in the housing 12 (e.g., within the confines of an inner loop formed by the chain 28) to abate the direct intermixing of thermal energy between the hot and cool liquid zones 34, 36. A water pump 52 is also provided to create a circulating water current 54 that may be located proximate the lower area 16 of the housing 12 (e.g., below the baffle 50 and outside the confines of the chain 28). The circulating water current 54 forms a water curtain so as to further inhibit the intermixing of thermal energy between the hot liquid zone 34 and the cold liquid zone 36 in the lower area 16.

Continuing to refer to FIG. 1, gas or fluid-tight containers 56, 58, 60, 62 are attached to the chain 28 by brackets 64 and are immersed in the liquid 32. The containers 56, 58, 60, 62 are adapted to move sequentially through the hot and cold zones 34, 36 so as to cause the chain 28 and the sprockets 22, 24 to rotate. In order to cause such rotation, each of the containers 56, 58, 60, 62 is provided with a working fluid 66 which may be air, carbon dioxide, refrigerant or any other fluid know in the art. The working fluid 66 is adapted to expand and contract in order to cause the volume of the containers 56, 58, 60, 62 to increase or decrease. The construction and operation of the containers 56, 58, 60, 62 will be discussed below in greater detail.

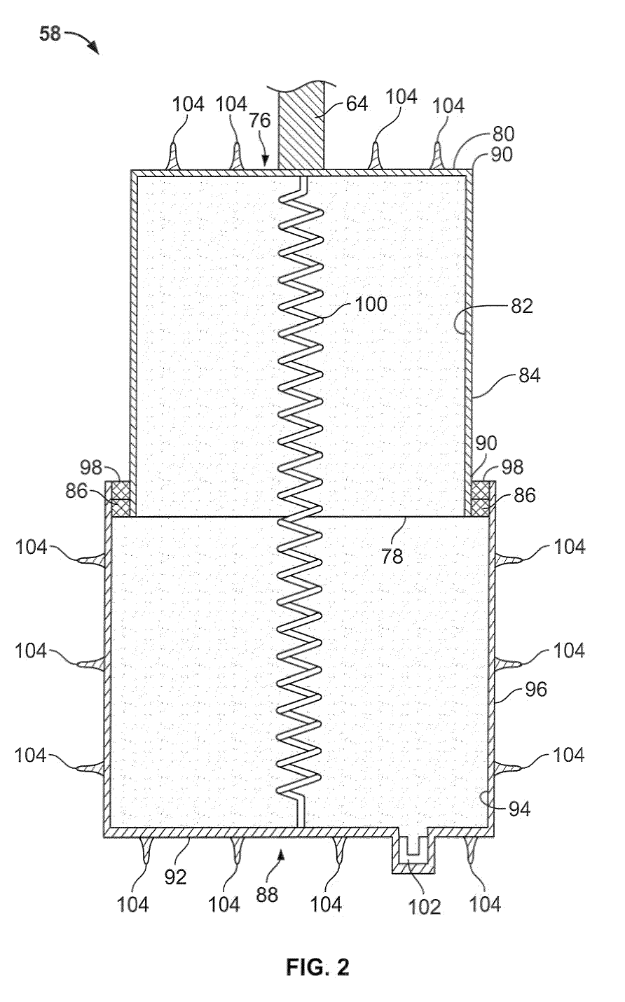

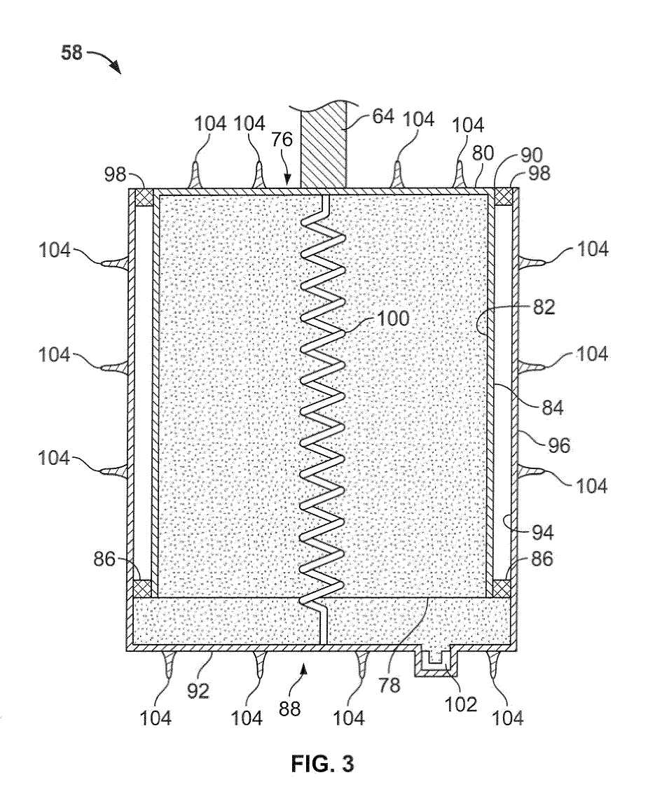

Referring to FIGS. 2 and 3, the container 58 includes an inner cylinder 76, which has an open end 78 and a closed end 80, and inner and outer surfaces 82, 84. The container 58 also includes an outer cylinder 88 having an open end 90 and a closed end 92, as well as inner and outer surfaces 94, 96. The outer cylinder 88 is slidably attached to the inner cylinder 76 such that the outer cylinder 88 is moveable relative to the inner cylinder 76 between a collapsed position, in which the inner cylinder 76 is positioned within the outer cylinder 88 (see FIG. 3), and an expanded position, in which the inner cylinder 76 extends outwardly from the outer cylinder 88 (see FIG. 2). A sealing ring 86 is positioned between the outer surface 84 of the inner cylinder 76 and the inner surface 94 of the outer cylinder 88 proximate the open end 78 so as to make the container 58 fluid tight. At least one retaining ring 98 is attached to the outer cylinder 88 proximate the open end 90 so as to prevent the outer cylinder 88 from sliding off the inner cylinder 76. A coil spring 100 or other suitable elastomeric urging element is also attached to the closed end 80 of the inner cylinder 76 and the closed end 92 of the outer cylinder 88 so as to urge the outer cylinder 88 to move towards its collapsed position. A valve 102 is provided for filling the container 58 with the working fluid 66. Fins 104 are disposed on the outer surfaces 84, 96 of the inner and outer cylinders 76 and 88, respectively, so as to facilitate the transfer of heat into and out of the working fluid 66 contained therewithin. The inner and outer cylinders 76 and 88 may be fabricated from any suitable corrosion resistant, thermally conductive material (e.g., plastic or metal).

Each of the containers 56, 60, 62 has a construction and operation which are identical to those of the container 58 illustrated in FIGS. 2 and 3. In such circumstances, the specific construction of the containers 56, 60, 62 will not be discussed herein.

The operation of the engine 10 will now be discussed with reference to FIG. 1. In FIG. 1, the containers 56, 58 are located in the hot liquid zone 34, while the containers 60, 62 are located in the cold liquid zone 36. The working fluid 66 in each of 1o the containers 56, 58 absorbs thermal energy from the hot liquid zone 34 and expands, causing the outer cylinders 88 to move from their contracted positions (see FIG. 3) to their expanded positions (see FIG. 2) and thereby causing the volume of the containers 56, 58 to increase (i.e., the containers 56, 48 expand to an expanded volume). Since the working fluid 66 in the containers 56, 58 has an increased volume but the same mass, it provides increased buoyant forces 68, 70 acting on the containers 56, 58, respectively. In contrast, the working fluid 66 in each of the containers 60, 62 releases its thermal energy to the cold liquid zone 36 and contract, causing the outer cylinders 88 to move from their expanded positions (see, e.g., FIG. 2) to their contracted positions (see, e.g., FIG. 3) and thereby causing the volume of the containers 60, 62 to decrease (i.e., the containers 60, 62 contract to a decreased volume). Since the working fluid 66 in the containers 60, 62 has a decreased volume but the same mass, it provides decreased buoyant forces 72, 74 acting the containers 60, 62, respectively. As a result, the sum of the buoyant forces 68, 70 acting on the containers 56, 58 is greater than the sum of the buoyant forces 72, 74 acting in the containers 60, 62, thereby resulting in a resultant force F which causes the chain 28 to rotate in a clockwise direction (as indicated by arrow R in FIG. 1). As a result of the continuous flow of thermal energy into and out of the hot and cold liquid zones 34, 36, respectively, the containers 56, 58, 60, 62 continuously move between the hot and cold liquid zones 34, 36, thereby imparting continuously motion to the chain 28. The movement of the chain 28 imparts rotational kinetic energy to the upper and lower sprockets 22, 24 and hence the shafts 18, 20. A suitable mechanism may be employed to store and/or utilize the rotational kinetic energy of the shafts 18, 20. For example, an electric generator G (shown in phantom in FIG. 1) may be driven by the shaft 18 via a belt B to convert the kinetic energy to electric energy.

It should be noted that the present invention can have numerous modifications and variations. For instance, the containers 56, 58, 60, and 62 may be fabricated from expandable and contractible components that are formed in different sizes and shapes, such as a balloon-shaped bladder fabricated from a single piece of elastomeric material. Individual engines may be fabricated with a combination of differently sized and shaped containers. The retaining ring 98 may also be sized and shaped to function as a back-up sealing ring (i.e., it may function as a secondary seal to contain the working fluid 66 in the containers 56, 58, 60, 62, should the sealing ring 86 leak). The surface of the liquid 32 may be set at an elevation (not shown) in the housing 12 such that the upper sprocket 22 is submerged in the liquid 32 and the containers 56, 58, 60, 62 are submerged in the liquid through their movement between the hot and cold liquid zones 34, 36.

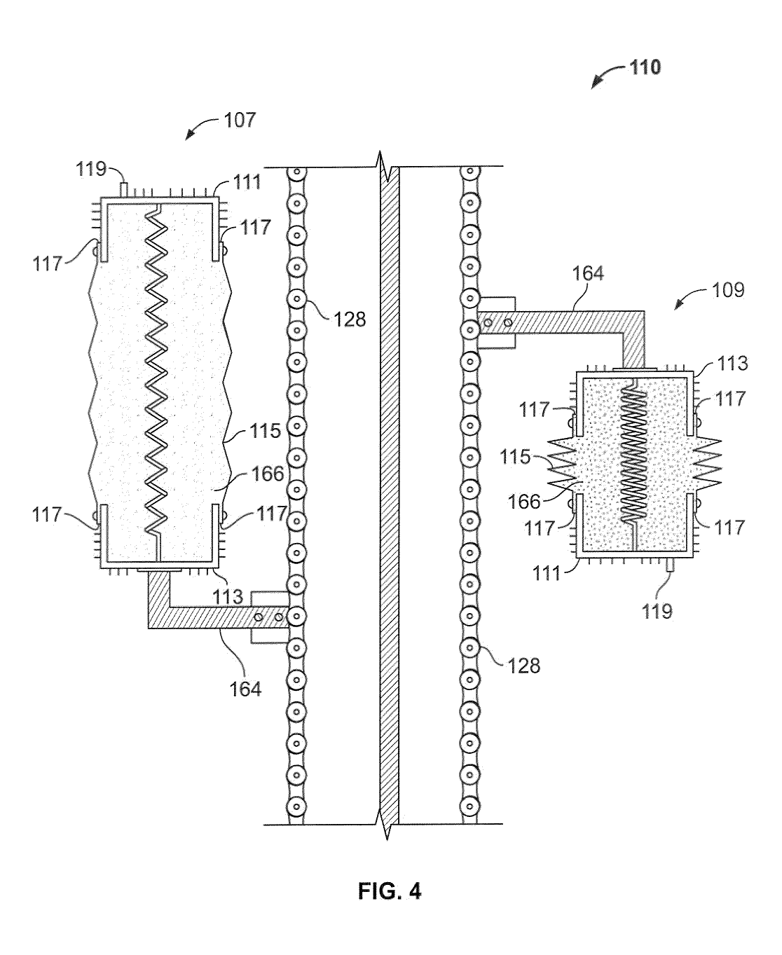

FIG. 4 illustrates a second exemplary embodiment of the present invention. The elements illustrated in FIG. 4, which correspond to the elements described above with reference to FIGS. 1-3, have been designated by corresponding reference numerals increased by one hundred, while new elements are designated by odd reference numerals in the one hundreds. The embodiment shown in FIG. 4 operates and is constructed in a manner consistent with the embodiment of FIGS. 1-3, unless otherwise indicated.

Referring to FIG. 4, an engine 110 is illustrated having gas or liquid-tight containers 107 and 109 that are attached to a chain 128 by brackets 164. It is noted that FIG. 4 illustrates only a portion of the engine 110, which may be provided with additional containers (not shown) that are identical, in construction and operation, to the containers 107 and 09. It is noted that the engine 110 is identical to the engine 10 in all respects, except that the containers 56, 58, 60, 62 are provided with a different construction. The construction of the containers 107, 109 is discussed below.

Each of the containers 107 and 109 has a pair of rigid caps 111, 113 that are attached to a bellow 115 by seals 117. The bellows 115 are fabricated out of flexible material such as rubber. The bellows 115 facilitate the movement of the containers 107, 109 from a contracted position (see the container 109 in FIG. 4) to an expanded position (see the container 107 in FIG. 4) and visa versa.

The present invention provides a number of benefits. For instance, the conversion of renewable thermal energy to kinetic energy is performed in an environmentally friendly and cost effective manner. The production of kinetic energy is provided in a mechanically simple manner (i.e., the force F produces motion in the chain 28 which imparts rotational kinetic energy to the sprockets 22, 24 and hence the shafts 18, 20).

It will be understood that the embodiments described herein are merely exemplary and that a person skilled in the art may make many variations and modifications without departing from the spirit and scope of the invention. All such variations and modifications are intended to be included within the scope of the invention as defined in the appended claims.

I claim:

1. Apparatus for converting thermal energy to kinetic energy, comprising a body of fluid having a first zone and a second zone; a thermal energy source thermally connected to said first zone for providing thermal energy to said first zone; a thermal energy sink thermally connected to said second zone for removing thermal energy from said second zone; a movable loop extending between said first zone and said second zone; and a plurality of fluid-tight containers immersed in said body of fluid and attached to said loop, each of said containers being moveable between said first zone and said second zone and having a working fluid therein, said working fluid of each of said containers absorbing thermal energy and thereby causing a corresponding one of said containers to expand to a first volume when said corresponding one of said containers is in said first zone and releasing thermal energy therefrom and thereby causing said corresponding one of said containers to contract to a second volume when said corresponding one of said containers is in said second zone, whereby the expansion and contraction of said containers cause said containers and hence said loop to move.

2. The apparatus of claim 1, wherein said working fluid of each of said containers provides a first buoyant force and a second buoyant force when a corresponding one of said containers is in said first volume and said second volume, respectively, said first buoyant force being greater than said second buoyant force.

3. The apparatus of claim 2, wherein at least one of said containers is positioned in said first zone, and at least one of said containers is positioned in said second zone, said first buoyant force acting on said at least one of said containers in said first zone being greater than said second buoyant force acting on said at least one of said containers in said second zone, whereby said loop is caused to move in a predetermined direction.

4. The apparatus of claim 3, wherein at least two of said containers are positioned in said first zone, and at least two of said containers are positioned in said second zone, the sum of said first buoyant forces acting on said at least two of said containers in said first zone are greater than the sum of said second buoyant forces acting on said at least two of said containers in said second zone.

5. The apparatus of claim 4, wherein said loop is oriented generally vertically, said first zone is positioned on one lateral side of said loop, and said second zone is positioned on an opposite lateral side of said loop.

6. The apparatus of claim 5, further comprising a housing containing said body of water and having an upper end and a lower end; first and second sprockets, said first sprocket being positioned adjacent said upper end of said housing, said second sprocket being positioned adjacent said lower end of said housing, said loop being looped over said first and second sprockets for causing said first and second sprockets to rotate in response to the movement of said loop; and first and second shafts connected to said first and second sprockets, respectively, for rotation therewith.

7. The apparatus of claim 6, further comprising means coupled to at least one of said first and second shafts for using kinetic energy associated with said at least one of said first and second shafts.

8. The apparatus of claim 7, wherein said means includes an electric generator.

9. The apparatus of claim 6, further comprising a baffle positioned between said first and second zones so as to inhibit intermixing of fluid between said first and second zones.

10. The apparatus of claim 9, wherein said baffle extends between said first and second sprockets and is positioned within said loop.

11. The apparatus of claim 10, further comprising creating means for creating a water curtain below said second sprocket so as to inhibit intermixing of fluid between said first and second zones.

12. The apparatus of claim 3, wherein said thermal energy source includes a first heat exchanger, which is positioned in said first zone, and an external energy source, which is connected to said heat exchanger.

13. The apparatus of claim 12, wherein said external energy source includes a renewable energy source.

14. The apparatus of claim 13, wherein said thermal heat sink includes a second heat exchanger, which is positioned in said second zone, and an external heat sink, which is connected to said second heat exchanger.

15. The apparatus of claim 14, wherein said external heat sink includes a renewable energy sink.

16. The apparatus of claim 3, wherein each of said containers includes a first cylinder and a second cylinder, said first cylinder of each of said containers being attached to said loop, said second cylinder of each of said containers being movably mounted to said first cylinder of a corresponding one of said containers.

17. The apparatus of claim 16, wherein said second cylinder of each of said containers is movable between a first position, in which it is in said first volume, and a second position, in which it is in said second volume, said second cylinder of each of said containers moving to said first position when a corresponding one of said containers is in said first zone, said second cylinder of each of said containers moving to said second position when a corresponding one of said containers is in said second zone.

18. The apparatus of claim 17, wherein each of said containers includes an urging element connected to said first and second cylinders of a corresponding one of said containers for urging said first and second cylinders towards each other.

19. The apparatus of claim 3, wherein each of said containers includes a bellow such that a corresponding one of said containers can expand to its said first volume and contract to its said second volume.

20. The apparatus of claim 3, wherein said loop includes a chain loop.
